(19) United States
(12) Patent Application Publication
(10) Pub. No.: US 2005/0086423 A1
(43) Pub. Date: Apr. 21, 2005

(54) System and method for implementing a NAND memory interface

(76) Inventor: Clifford A. Zitlaw, San Jose, CA (US)

Correspondence Address: SAWYER LAW GROUP LLP, P.O. Box 51418, Palo Alto, CA, 94303, US

(21) Appl. No.: 10/688,042

(22) Filed: Oct. 17, 2003

(51) Int. Cl. G06F 12/00

(52) U.S. Cl. 711/105

(57) ABSTRACT

A system and method for implementing a NAND memory interface for an embedded PC system are disclosed. The system and method include a NAND interface device adapted to be coupled to a first chip select of a dedicated SDRAM bus, and at least one NAND memory device coupled to the NAND interface device. The first chip select is utilized to access the NAND memory device via the NAND interface device. Accordingly, the NAND interface device and the at least one NAND memory device function substantially as a hard disk in the embedded PC system. As a result, lower costs for non-volatile memory are achieved while increasing speed and decreasing motherboard PCB real estate requirements.

### FIELD OF THE INVENTION

The present invention relates to memory systems, and more particularly to a system and method for implementing a NAND memory interface.

### BACKGROUND OF THE INVENTION

Embedded PC systems are computer systems tailored to “non-desktop” applications such as cash registers, instant teller machines, kiosks, digital set top boxes, etc. Embedded PC systems implement legacy PC architecture in a form factor, i.e., motherboard size, tailored to “non-desktop” applications. The platforms for these applications include some form of non-volatile memory to act as storage for data and applications programs.

FIG. 1 is a block diagram of a conventional embedded PC system 50, which includes a processor 52, a synchronous dynamic random access memory (SDRAM) dual inline memory module (DIMM) 54, and a hard disk 56. The processor 52 connects to the SDRAM DIMM 54 via a northbridge 58 and a dedicated SDRAM bus 60. The processor 52 connects to the hard disk 56 via the northbridge 58, a southbridge 62, and a hard disk interface 64.

The northbridge 58 allows the processor 52 to access the system's high-speed peripherals. The northbridge 58 typically allows access to a video subsystem (not shown), the SDRAM DIMM 54, the SDRAM bus 60, and the southbridge 62. The southbridge 62 allows the processor 52 access to the system's lower speed peripherals. The southbridge 62 interfaces to lower speed peripherals including the hard disk 56, a hard disk interface 64, a keyboard, printer ports, and serial ports, which are not shown for simplicity of illustration. Interactions between the processor 52 and the southbridge 62 are managed by the northbridge 58. Note that the SDRAM DIMM 54 is interfaced to the northbridge 58 through the dedicated high-speed SDRAM bus 60 and the hard disk 56 is interfaced to the southbridge 62 through the relatively low-speed hard disk interface 64.

Embedded PC systems require some form of non-volatile memory for data and program storage. Hard disks are often chosen to provide this non-volatile storage. A problem with hard disks is that they have a relatively high base price for the lowest available densities. The price for the lowest density drives has remained relatively unaffected by technological developments that have driven down the costs of higher density drives.

Embedded PCs often do not require as much storage capacity as is offered by even the lowest density hard disk. In these “lower density” applications a developer will often find that solid state hard disk equivalents offer a cost effective alternative. These solid state alternatives provide lower price points and lower densities. The solid state alternative will often be chosen by a developer if it has adequate capacity and its price is lower than the least expensive hard disk. A solid state hard disk might also be chosen due to reliability issues related to solid state memories.

One conventional alternative to the hard disk is a Disk On Chip™ (DOC). The DOC often uses NAND electrically erasable programmable read-only memory (EEPROM) as the bulk solid state memory. The DOC includes an embedded controller to control the NAND EEPROM. The DOC is connected to the processor via the southbridge and the northbridge. To connect to the southbridge, the DOC often shares an external memory bus with a BIOS chip.

A problem with the DOC is that it is expensive. The DOC is expensive because it includes an embedded controller that is substantially complex. The embedded controller is complex, because it typically includes a central processing unit (CPU), random access memory (RAM), read only memory (ROM), clock circuits, and various peripheral circuits. Unfortunately, this complexity adds to the total cost of the DOC. Furthermore, while the DOC has gained significant popularity, it is a niche product and thus costs a premium.

Another problem with the DOC is that its embedded controller limits the possible bandwidth between the NAND EEPROM memory and the external memory bus. The bandwidth is limited because the embedded controller performs error detection and correction on the raw data from the NAND EEPROM before presenting the final data onto the external memory bus.

Yet, another problem with the DOC is that it requires dedicated real estate on the motherboard of embedded PC system.

Another conventional alternative to the hard disk a Compact Flash Card™ (CFC). Similar to the DOC, the CFC uses NAND EEPROM as the bulk solid state memory and uses an embedded controller to control the NAND EEPROM.

A problem with the CFC is that it is expensive. Like the DOC, the CFC uses an expensive embedded controller, which includes a CPU, RAM, ROM, clock circuits, and various peripheral circuits. In addition, the CFC also requires its own printed circuit board (PCB), a package to house the CFC PCB, and a special CFC connector, all of which add to the total cost of the CFC. Furthermore, the CFC solution requires the motherboard to allocate dedicated real estate and include a dedicated CFC connector.

Yet, another problem with the CFC is that the embedded controller of the CFC limits the possible bandwidth between the NAND memory and the external memory bus, for similar reasons described above with regard to the DOC.

Accordingly, what is needed is an improved system and method for implementing a non-volatile memory interface. The system and method should be simple, cost effective and capable of being easily adapted to existing technology. The present invention addresses such a need.

### SUMMARY OF THE INVENTION

A system and method for implementing a NAND memory interface for an embedded PC system are disclosed. The system and method comprise a NAND interface device adapted to be coupled to a first chip select of a dedicated SDRAM bus, and at least one NAND memory device coupled to the NAND interface device. The first chip select is utilized to access the NAND memory device via the NAND interface device. Accordingly, the NAND interface device and the at least one NAND memory device function substantially as a hard disk in the embedded PC system. As a result, lower costs for non-volatile memory are achieved while increasing speed and decreasing motherboard PCB real estate requirements.

### BRIEF DESCRIPTION OF THE DRAWINGS

FIG. 1 is a block diagram of a conventional embedded PC system.

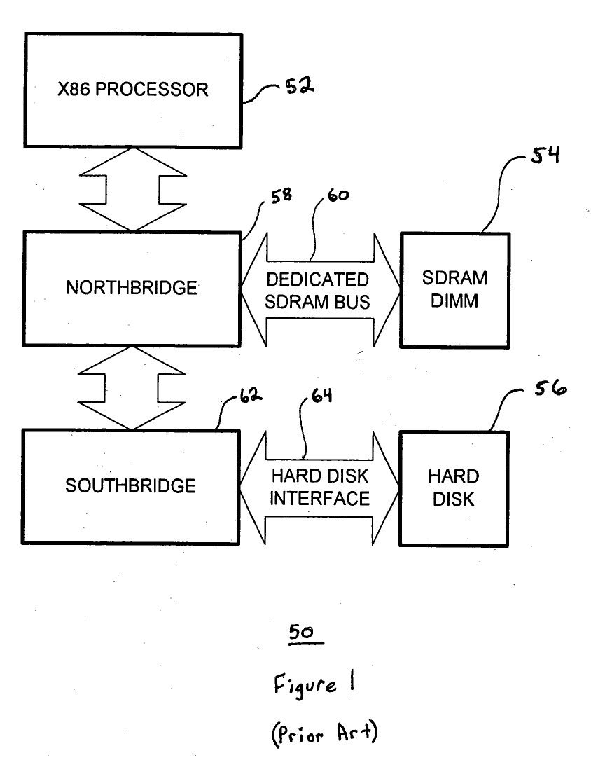

FIG. 2 is a block diagram of an embedded PC system in accordance with the present invention.

FIGS. 3A and 3B are PCB layouts showing front and back views, respectively, of the memory module of FIG. 2 in accordance with a preferred embodiment of the present invention.

FIGS. 4A and 4B are PCB layouts showing front and back views, respectively, of the memory module of FIG. 2 in accordance with another embodiment of the present invention.

FIG. 5 is a block diagram of a chip set, which can be used to implement the embedded PC system of FIG. 2, including the memory module of FIGS. 3A and 3B in accordance with the present invention.

FIG. 6 is simple flow chart showing the operation of the embedded PC system of FIG. 2, including the memory module of FIGS. 3A and 3B, in accordance with a preferred embodiment present invention.

FIG. 7 is a schematic diagram of the chip set for the memory module 104 of FIGS. 3A, 3B, and 5 in accordance with the present invention.

### DETAILED DESCRIPTION

The present invention relates to memory systems, and more particularly to a system and method for implementing a NAND memory interface. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A system and method in accordance with the present invention for implementing a NAND memory interface are disclosed. In a preferred embodiment, the NAND memory interface can be implemented utilizing a DIMM, which is populated with a NAND subsystem on a typically unused side of the DIMM and populated with one or more SDRAM devices on the other side. The NAND subsystem comprises a NAND memory interface device and one or more commodity NAND memory devices. A first chip select from a dedicated SDRAM bus is utilized to access the SDRAM devices, and a second chip select from the dedicated SDRAM bus is utilized to access the NAND memory devices. Accordingly, the NAND subsystem functions as and/or replaces a hard disk and/or hard disk equivalents in an embedded PC system. Because the NAND memory and bus interface devices can be commodity products, the overall cost to implement the NAND subsystem is kept at a minimum. Furthermore, because the NAND memory devices populate the typically unused portion of the DIMM, no motherboard real estate is required to support this hard disk equivalent. To more particularly describe the features of the present invention, refer now to the following description in conjunction with the accompanying figures.

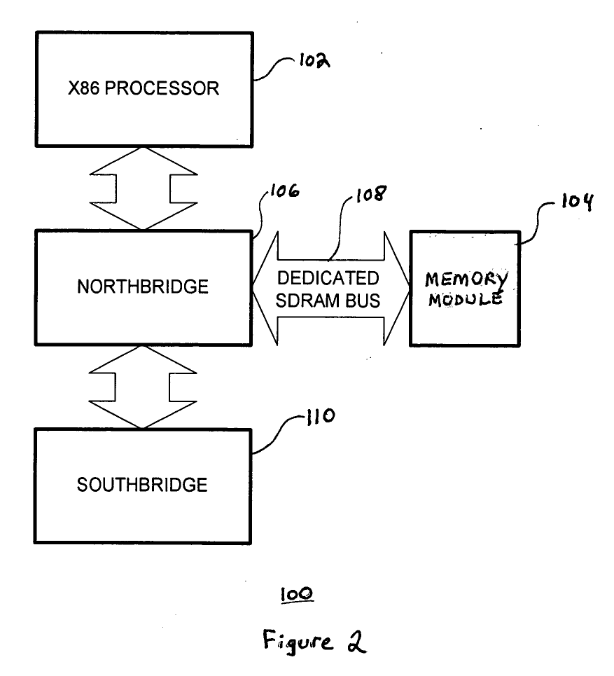

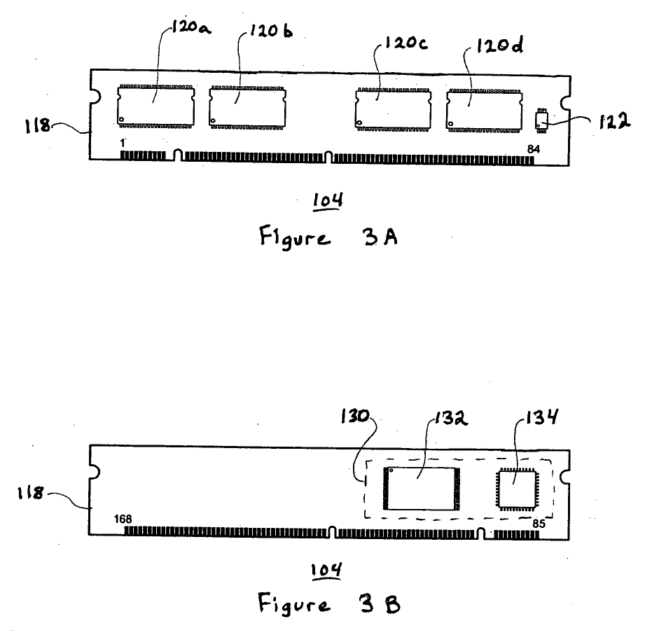

FIG. 2 is a block diagram of an embedded PC system 100 in accordance with the present invention. The embedded PC system 100 includes a processor 102, which is coupled to a memory module 104 via a northbridge 106 and a dedicated SDRAM bus 108. The processor 102 and the northbridge 106 are shown separately but can alternatively be integrated as one unit. A southbridge 110 interfaces to lower speed peripherals including, a keyboard, printer ports, and serial ports, which are not shown for simplicity of illustration. For a more detailed description of the memory module 104, refer now to FIGS. 3A and 3B together.

FIGS. 3A and 3B are PCB layouts showing front and back views, respectively, of the memory module 104 of FIG. 2 in accordance with a preferred embodiment of the present invention. The memory module 104 is implemented as an SDRAM-NAND DIMM, which can be extended to various DIMM form factors. No separate packaging is required.

The memory module 104 comprises a PCB 118, one or more SDRAM devices 120a-d and a serial presence detect (SPD) device 122 on the front side of the PCB 118 (FIG. 3A), and a NAND subsystem 130 on the back side of the PCB 118 (FIG. 3B).

The configuration of the SDRAM devices and the NAND subsystem on the PCB 118 will vary, depending on the specific application, and variations of the configuration would still be within the spirit and scope of the present invention. For example, the SDRAM devices 120a-d can populate the back side and the NAND subsystem 130 can populate the front side. Alternatively, the SDRAM devices 120a-d and the NAND subsystem 130 can populate each side of the PCB 118. Alternatively, the SDRAM devices 120a-d and the NAND subsystem 130 can populate only one side of the PCB 118, the back side or the front side, thereby leaving one side unpopulated.

The NAND subsystem 130 comprises at least one NAND memory device 132 and a NAND interface device 134, which coordinates data transfer between the NAND memory device 132 and a dedicated SDRAM bus (not shown). The appropriate density of the SDRAM devices 120a-d and the NAND device 132 can vary and will depend on the specific application.

In a preferred embodiment, the NAND interface device 134 is placed between the NAND memory device 132 and the dedicated SDRAM bus 108. The NAND interface device 134 allows the processor 102 direct access to the NAND memory device 132. The processor 102 performs any required error detection and correction on the raw data from the NAND memory device 132. Because the processor 102 performs error detection and correction, the complex and costly embedded controller found in DOC and CFC products can be replaced with the simpler NAND interface device 134. Overall system throughput is enhanced because the processor 102 is higher performance than the embedded controller found in DOC and CFC products.

In a preferred embodiment, the memory module 104 utilizes an existing SDRAM infrastructure to facilitate support for both SDRAM and NAND memory. A typical SDRAM DIMM includes a PCB that is populated only on one side, typically the front side, and is populated with SDRAM devices. In accordance with the present invention, an SDRAM DIMM can be converted into an SDRAM-NAND DIMM by populating the unused side, typically the back side, with the NAND subsystem 130.

Accordingly, the NAND subsystem 130 functions substantially as a hard disk in the embedded PC system 100; that is, the NAND subsystem 130 can replace a hard disk and/or hard disk equivalents in the embedded PC system. This is accomplished using unused real estate on the DIMM. In other words, no dedicated motherboard PCB real estate is required. Furthermore, commodity NAND devices can be used to implement the NAND subsystem 130 so that the memory module 104 can support an embedded PC system's volatile and non-volatile memory in a cost effective manner.

In a preferred embodiment, the memory module 104 can usually be coupled to a dedicated SDRAM bus via an existing (DIMM) slot (not shown) without any hardware modifications. Since no additional dedicated hard drive/DOC/CFC connector is required, valuable motherboard PCB real estate can be preserved. Alternatively, at least the SDRAM devices 120a-d and the NAND subsystem 130 from the memory module 104 can be adapted to be soldered directly to the dedicated SDRAM bus.

Although the present invention disclosed is described in the context of a preferred embodiment, one of ordinary skill in the art will readily recognize that there could be variations to the embodiments and those variations would be within the spirit and scope of the present invention. For example, the present invention can be applied to other types of memory modules. Furthermore, the memory module 104 can be implemented to interface with different non-volatile (i.e., NAND and non-NAND) memory devices. Furthermore, the memory module 104 can be extended to various SDRAM technologies.

It should be emphasized that SDRAM technologies comprise any SDRAM technologies that are synchronous in nature. Examples of such SDRAM technologies include but are not limited to single data rate (SDR) SDRAM, double data rate (DDR) SDRAM, and Rambus DRAM (RDRAM), etc. Furthermore, although the memory module 104 applies to synchronous technologies, the memory module 104 can also apply to non-synchronous technologies and would still be within the spirit and scope of the present invention.

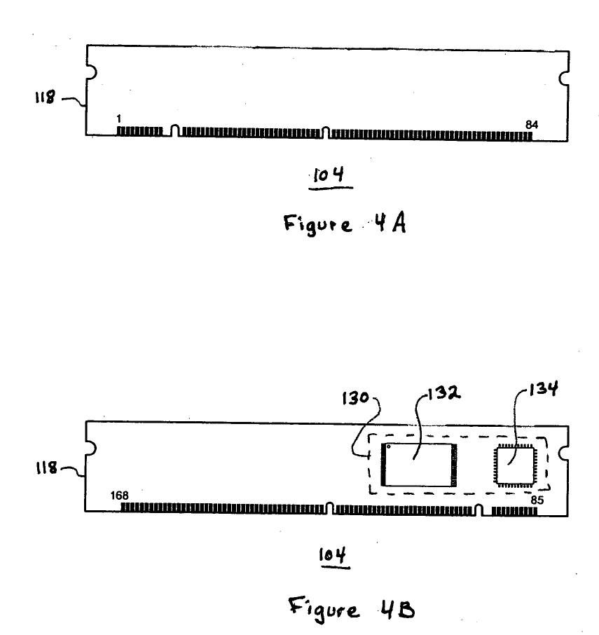

FIGS. 4A and 4B are PCB layouts showing front and back views, respectively, of the memory module 104 of FIG. 2 in accordance with another embodiment of the present invention. Referring to FIGS. 4A and 4B together, the memory module 104 is populated with the NAND subsystem 130 on the back side of the PCB 118 (FIG. 4B) and the front side (FIG. 4A) is unused. The NAND subsystem 130 of FIG. 4B operates similarly to the NAND subsystem 130 of FIG. 3B. In an alternative embodiment, the NAND subsystem 130 can populate the front side of the PCB 118. Alternatively, the front side and/or the back side can be populated with additional NAND memory devices.

Still referring to FIG. 4B, the memory module 104 can be coupled to a dedicated SDRAM bus via an existing (DIMM) slot (not shown) and can share the dedicated SDRAM bus with another DIMM (e.g., with a conventional SDRAM-only DIMM). Alternatively, the NAND subsystem 130 can be adapted to be soldered directly to the dedicated SDRAM bus. As such, the NAND interface device 134 can be soldered directly to the dedicated SDRAM bus and the NAND memory device 132 can be soldered directly to the NAND interface device 134.

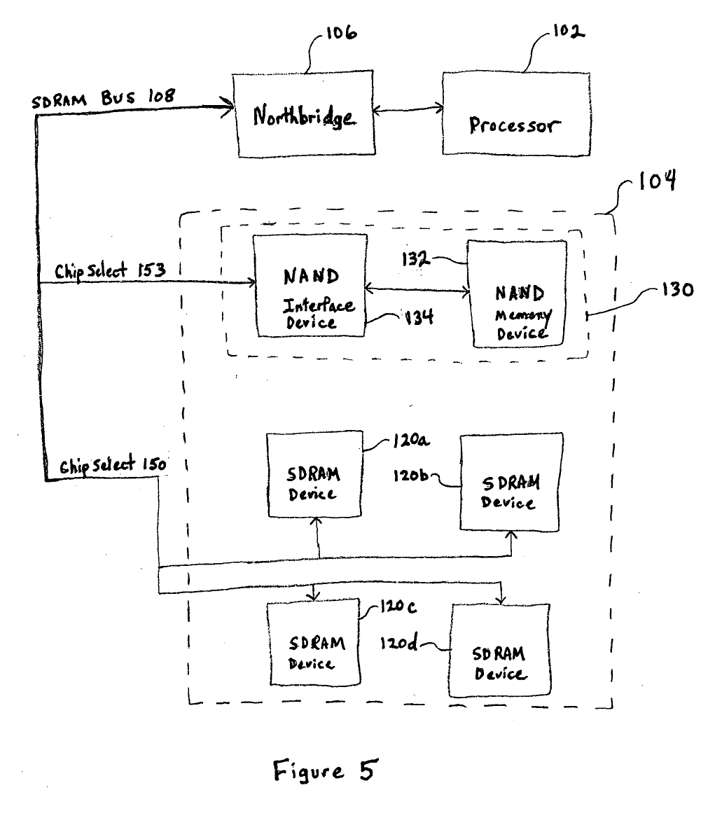

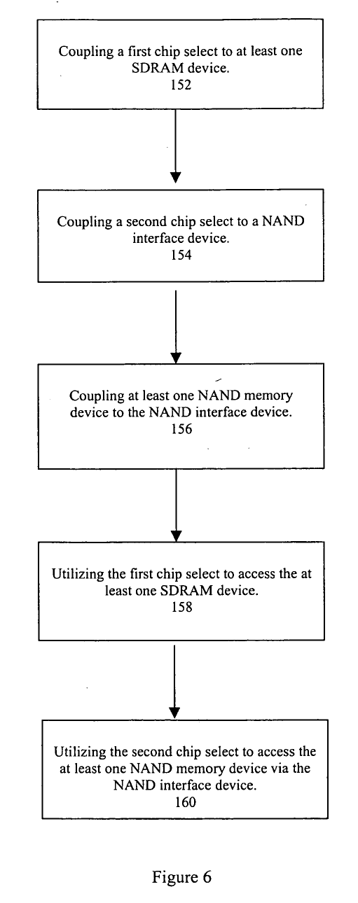

To more fully describe the method and system of the present invention, refer now to the following description in conjunction with FIGS. 5 and 6 together. FIG. 5 is a block diagram of a chip set, which can be used to implement the embedded PC system 100 of FIG. 2, including the memory module 104 of FIGS. 3A and 3B in accordance with the present invention. FIG. 6 is simple flow chart showing the operation of the embedded PC system 100 of FIG. 2, including the memory module 104 of FIGS. 3A and 3B, in accordance with a preferred embodiment of the present invention.

First, a first chip select 150 is coupled to at least one SDRAM device 120a-d, via a step 152. Next, a second chip select 153 is coupled to a NAND interface device 134, via a step 154. The first chip select 150 and the second chip select 153 are from a dedicated SDRAM bus 108. Next, at least one NAND memory device 132 is coupled to the NAND interface device 134, via a step 156. Next, the first chip select 150 is utilized to access the at least one SDRAM device 120a-d, via a step 158. Finally, the second chip select 153 is utilized to access the at least one NAND memory device 132 via the NAND interface device 134, via a step 160.

The high-speed nature of the dedicated SDRAM bus 108 allows the NAND subsystem 130 to provide significant improvements in raw read/write throughput when compared with other non-volatile memory alternatives. The dedicated SDRAM bus 108 can be extended to different data bus widths, including 8 bits, 16 bits, 32 bits, and more.

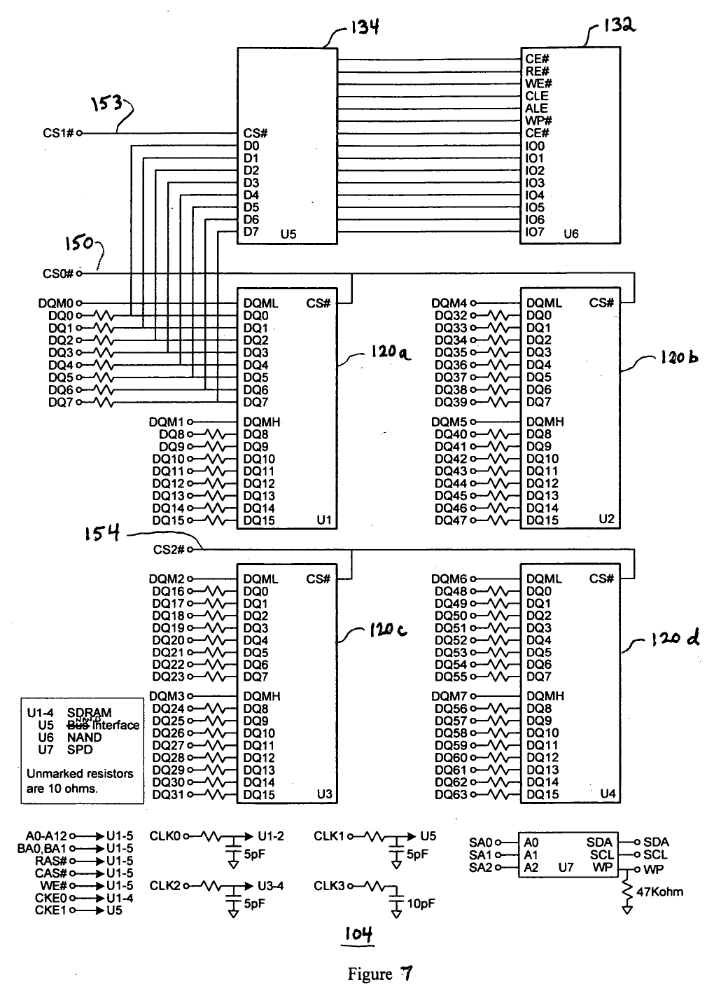

FIG. 7 is a schematic diagram of the chip set for the memory module 104 of FIGS. 3A, 3B, and 5 in accordance with the present invention. Note that a chip select 154 of FIG. 7 is typically tied to the chip select 150 shown in FIGS. 5 and 7.

The schematic of FIG. 7 is shown as an example of a preferred embodiment. One of ordinary skill in the art will readily recognize that there can be variations to the embodiments and those variations would be within the spirit and scope of the present invention.

According to the system and method of the present invention disclosed herein, the present invention provides numerous benefits. For example, the NAND subsystem is a high-performance, low-cost alternative to existing non-volatile memory solutions such as hard disks, CFCs, and DOCs. In addition, the system and method utilizes cost-effective products for both the bus interface device and the non-volatile memory device and saves valuable motherboard PCB real estate on the motherboard of embedded PC systems.

A system and method in accordance with the present invention for implementing a NAND memory interface are disclosed. In a preferred embodiment, the NAND memory interface can be implemented utilizing a DIMM, which is populated with a NAND subsystem on a typically unused side of the DIMM and populated with one or more SDRAM devices on the other side. The NAND subsystem comprises a NAND memory interface device and one or more commodity NAND memory devices. A first chip select from a dedicated SDRAM bus is utilized to access the SDRAM devices, and a second chip select from the dedicated SDRAM bus is utilized to access the NAND memory devices. Accordingly, the NAND subsystem functions as and/or replaces a hard disk and/or hard disk equivalents in an embedded PC system. Because the NAND memory and bus interface devices can be commodity products, the overall cost to implement the NAND subsystem is kept at a minimum. Furthermore, because the NAND memory devices populate the typically unused portion of the DIMM, no motherboard real estate is required to support this hard disk equivalent.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A memory module for an embedded PC system, the memory module comprising:
a NAND interface device adapted to be coupled to a first chip select of a dedicated SDRAM bus; and
at least one NAND memory device coupled to the NAND interface device, wherein the first chip select is utilized to access the NAND memory device via the NAND interface device, and wherein the NAND interface device and the at least one NAND memory device function substantially as a hard disk in the embedded PC system.

2. The memory module of claim 1 further comprising at least one synchronous dynamic random access memory (SDRAM) device adapted to be coupled to a second chip select of the dedicated SDRAM bus, wherein the second chip select is utilized to access the at least one SDRAM device.

3. The memory module of claim 2 wherein the at least one SDRAM device is coupled to a first side of the memory module and wherein the at least one NAND memory device is coupled to a second side of the memory module.

4. The memory module of claim 2 wherein the at least one SDRAM device and the NAND interface device can be adapted to be soldered directly to the dedicated SDRAM bus, and wherein the at least one NAND memory device can be adapted to be soldered directly to the NAND interface device.

5. The memory module of claim 1 wherein the NAND interface device can be adapted to be soldered directly to the dedicated SDRAM bus, and wherein the at least one NAND memory device can be adapted to be soldered directly to the NAND interface device.

6. The memory module of claim 1 wherein the memory module is adapted to be coupled to a dual inline memory module (DIMM) slot.

7. The memory module of claim 1 wherein the memory module is a dual inline memory module (DIMM).

8. An embedded PC system comprising:
a processor;
a dedicated SDRAM bus coupled to the processor; and
a memory module coupled to the SDRAM bus, the memory module comprising:
a NAND interface device adapted to be coupled to a first chip select of the dedicated SDRAM bus; and
at least one NAND memory device coupled to the NAND interface device, wherein the first chip select is utilized to access the NAND memory device via the NAND interface device, and wherein the NAND interface device and the at least one NAND memory device function substantially as a hard disk in the embedded PC system.

9. The memory module of claim 8 further comprising at least one synchronous dynamic random access memory (SDRAM) device adapted to be coupled to a second chip select of the dedicated SDRAM bus, wherein the second chip select is utilized to access the at least one SDRAM device.

10. The memory module of claim 9 wherein the at least one SDRAM device is coupled to a first side of the memory module and wherein the at least one NAND memory device is coupled to a second side of the memory module.

11. The memory module of claim 9 wherein the at least one SDRAM device and the NAND interface device can be adapted to be soldered directly to the dedicated SDRAM bus, and wherein the at least one NAND memory device can be adapted to be soldered directly to the NAND interface device.

12. The system of claim 8 wherein the NAND interface device can be adapted to be soldered directly to the dedicated SDRAM bus, and wherein the at least one NAND memory device can be adapted to be soldered directly to the NAND interface device.

13. The system of claim 8 wherein the memory module is adapted to be coupled to a dual inline memory module (DIMM) slot.

14. The system of claim 8 wherein the memory module is a dual inline memory module (DIMM).

15. A method for implementing a NAND memory interface, the method comprising:
(a) coupling a first chip select to a NAND interface device, wherein the first chip select is from a dedicated SDRAM bus;
(b) coupling at least one NAND memory device to the NAND interface device; and
(c) utilizing the first chip select to access the at least one NAND memory device via the NAND interface device, wherein the NAND interface device and the at least one NAND memory device function substantially as a hard disk in the embedded PC system.

16. The method of claim 15 wherein the first chip select coupling step (a) comprises the step of (a1) soldering the NAND interface device directly to the dedicated SDRAM bus.

17. The method of claim 16 wherein the at least one NAND memory device coupling step (b) comprises the step of (b1) soldering the at least one NAND memory device directly to the NAND interface device.

18. The method of claim 15 further comprising:
(d) coupling a second chip select to at least one SDRAM device, wherein the second chip select is from the dedicated SDRAM bus; and
(e) utilizing the second chip select to access the at least one SDRAM device.

19. The method of claim 18 further comprising:
(f) coupling the at least one SDRAM device to a first side of a memory module; and
(g) coupling the at least one NAND memory device to a second side of the memory module.

20. The memory module of claim 19 wherein the memory module is a dual inline memory module (DIMM).

21. The method of claim 18 wherein the second chip select coupling step (d) comprises the step of (d1) soldering the at least one SDRAM device directly to the dedicated SDRAM bus.

22. A computer-readable medium including program instructions for implementing a NAND memory interface, the program instructions comprising:
(a) coupling a first chip select to a NAND interface device, wherein the first chip select is from a dedicated SDRAM bus;
(b) coupling at least one NAND memory device to the NAND interface device; and
(c) utilizing the first chip select to access the at least one NAND memory device via the NAND interface device, wherein the NAND interface device and the at least one NAND memory device function substantially as a hard disk in the embedded PC system.

23. The computer-readable medium of claim 22 wherein the first chip select coupling step (a) comprises the step of (a1) soldering the NAND interface device directly to the dedicated SDRAM bus.

24. The computer-readable medium of claim 23 wherein at least one NAND memory device coupling step (b) comprises the step of (b1) soldering the at least one NAND memory device directly to the NAND interface device.

25. The computer-readable medium of claim 22 further comprising program instructions for:
(d) coupling a second chip select to at least one SDRAM device, wherein the second chip select is from the dedicated SDRAM bus; and
(e) utilizing the second chip select to access the at least one SDRAM device.

26. The computer-readable medium of claim 25 further comprising program instructions for:
(f) coupling the at least one SDRAM device to a first side of a memory module; and
(g) coupling the at least one NAND memory device to a second side of the memory module.

27. The computer-readable medium of claim 26 wherein the memory module is a dual inline memory module (DIMM).

28. The computer-readable medium of claim 25 wherein the second chip select coupling step (d) comprises the step of (d1) soldering the at least one SDRAM device directly to the dedicated SDRAM bus.
